(19) United States
(12) Patent Application Publication
(10) Pub. No.: US 2015/0273486 A1
(43) Pub. Date: Oct. 1, 2015

(54) EJECTION HEAD AND CONTAINER PROVIDED WITH THE SAME

(71) Applicant: Katsuhito KUWAHARA, (US)

(72) Inventor: Katsuhito Kuwahara, Koto-ku, Tokyo (JP)

(73) Assignee: YOSHINO KOGYOSHO CO., LTD., Tokyo (JP)

(21) Appl. No.: 14/438,453

(22) PCT Filed: Dec. 13, 2012
(86) PCT No.: PCT/JP2012/007980

§ 371 Date: Apr. 24, 2015

(30) Foreign Application Priority Data
Oct. 31, 2012 (JP) 2012-241258

(51) Int. Cl. B05B 1/02

(52) U.S. Cl. CPC B05B 1/02

(57) ABSTRACT

The ejection head includes a pressing member; a nozzle tip that is fitted to a concavity; and an insert member. The insert member includes: a concave portion that forms a filling space for the content medium; at least one through hole formed on a circumferential wall; and a long groove that extends from the through hole to the nozzle tip. The insert member has a front end having an outer circumferential edge formed as an annular inclined surface, and the front end is formed with a bulging portion. The bulging portion is formed with a plurality of radial grooves and a cylindrical groove. At least one through hole is located in a position that is circumferentially offset from the plurality of radial grooves.

### TECHNICAL FIELD

The present invention relates to an ejection head that includes an inner passage to which a stem is fixed and that ejects a content drawn from the stem to an outside by displacing the stem upward and downward.

### BACKGROUND

The present inventor has already proposed a known ejection head including a pressing member that drives a pump located in a container and a nozzle tip that is embedded with an insert member and is fixed to the pressing member, wherein the content is ejected through an orifice provided in the nozzle tip (Refer to Patent Literature 1, for example).

### CITATION LIST

### Patent Literature

### PTL 1: JP2011177627A

### SUMMARY

However, the present inventor conducted further tests and studies and has realized that the proposed ejection head still has room for improvement.

An objective of the present invention is to provide an ejection head that is capable of producing stable ejection patterns.

One aspect of the present invention resides in an ejection head, including: a pressing member that is fitted to a stem standing from a mouth tubular portion of a container body and that is formed with an introduction path to which a content medium is introduced; a nozzle tip that is fitted to a concavity formed on a side surface of the pressing member and that is formed with an ejection orifice for the content medium pumped from the introduction path; and an insert member that is located inside the nozzle tip and that forms a communication path allowing the introduction path formed in the pressing member to communicate with the ejection orifice formed in the nozzle tip. The insert member includes: a concave portion having an opening formed in a rear end of the insert member that faces to the pressing member, thereby forming a filling space to be filled with the content medium introduced from the introduction path; at least one through hole formed on a circumferential wall constituting the concave portion; and a long groove that is formed on the circumferential wall and that extends from the at least one through hole to the nozzle tip. The insert member has a front end facing to the nozzle tip, the front end having an outer circumferential edge formed as an annular inclined surface tapered toward a front end thereof, and the front end being formed with a bulging portion that protrudes forward of the inclined surface, the bulging portion being formed with a plurality of radial grooves and a cylindrical groove where the plurality of radial grooves joins, and at least one of the at least one through hole is located in a position that is circumferentially offset from the plurality of radial grooves.

Although the at least one through hole may of course include a through hole having a constant diameter, the at least one through hole may include a slant hole having a diameter that is increased in a direction from an inside to an outside of the insert member. Furthermore, the at least one through hole may be a single through hole that is located in a position that is circumferentially offset from the plurality of radial grooves.

The introduction path may include an opening formed in any position, for example, in an upper position. In this case, the opening allows the introduction path to communicate with the filling space.

Moreover, according to the present invention, the concavity may be provided with a plurality of bumps that form a plurality of radial grooves and a cylindrical groove where the plurality of radial grooves joins. By bringing the insert member into abutment with the plurality of bumps, a guiding path allowing the introduction path to communicate with the communication path may be formed.

Another aspect of the present invention resides in a pump container including an ejection head. The pump container includes the ejection head and a container body including a pump having a stem to which the ejection head is fitted.

According to the present invention, the insert member is located inside the nozzle tip to form the communication path communicating with the ejection orifice, and the through hole, which is formed on the circumferential wall of the insert member, is located in the position that is circumferentially offset from the radial grooves, which is formed on the front end of the insert member. With the above configuration, the ejection patterns, which are defined by states, angles, or the like of spraying, are better stabilized compared with conventional ejection patterns.

### BRIEF DESCRIPTION OF THE DRAWINGS

FIG. 1 is a side view taken along a partial section of a pump bottle container including a spray nozzle according to one embodiment of the present invention.

FIG. 2 is an enlarged sectional view of the spray nozzle according to the one embodiment.

FIG. 3 is an enlarged front view of a concave portion formed on a side surface of a pressing member according to the one embodiment.

FIG. 4A is a front view of an insert member according to the one embodiment, and FIG. 4B is a sectional view taken along a line A-A in FIG. 4A.

FIG. 5A is a side view of the insert member, and FIG. 5B is a perspective view of the insert member.

FIG. 6 is a sectional view taken along a line B-B in FIG. 2 that is partially virtual.

FIG. 7 is a schematic perspective view of a passage (a flow path) of a content medium passing between a nozzle tip and the insert member according to the one embodiment.

FIG. 8A is a schematic view of a state of spraying with use of the spray head according to the one embodiment, and FIG. 8B is a view of a state of spraying with use of a conventional spray head.

FIG. 9A is a partial bottom view of an exemplary protrusion formed in an upper end flange according to the one embodiment, and FIG. 9B is a sectional view taken along a line C-C in FIG. 9A.

FIG. 10A is a partial bottom view of another exemplary protrusion formed in the upper end flange according to the one embodiment, and FIG. 10B is a sectional view taken along a line D-D in FIG. 10A.

FIG. 11A is a partial bottom view of yet another exemplary protrusion formed in the upper end flange according to the one embodiment, and FIG. 11B is a sectional view taken along a line E-E in FIG. 11A.

FIG. 12A is an enlarged sectional view of an exemplary protrusion formed on a lower end surface of the pressing member according to the one embodiment, and FIG. 12B is an enlarged sectional view of an area X in FIG. 12A.

FIG. 13A is an enlarged sectional view of another exemplary protrusion formed on the lower end surface of the pressing member according to the one embodiment, and FIG. 13B is an enlarged sectional view of an area Yin FIG. 13A.

### DETAILED DESCRIPTION

One embodiment of a pump bottle container including a spray head of the present invention will be described in detail below with reference to the drawings.

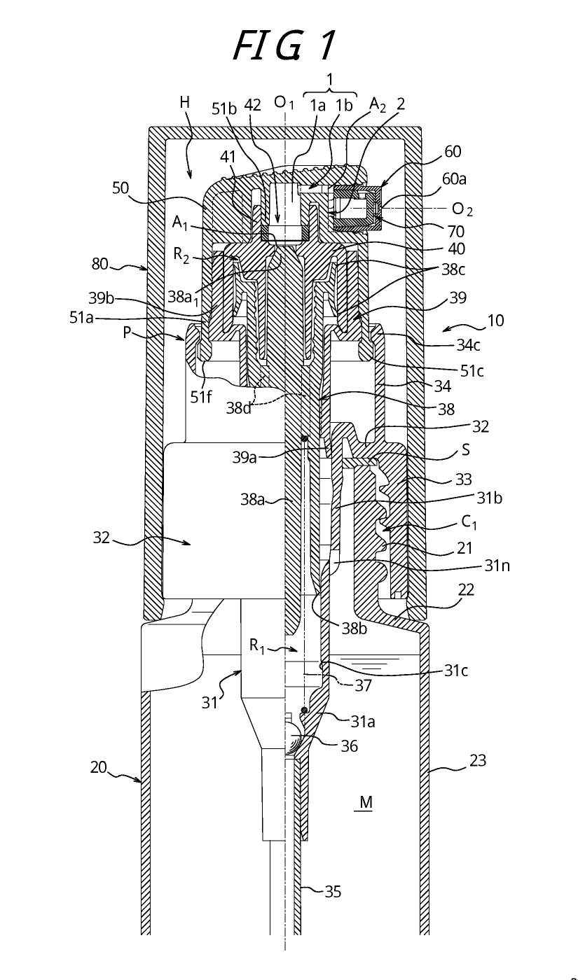

In FIG. 1, reference numeral 10 denotes the pump bottle container including a spray head H according to the one embodiment of the present invention. Reference numeral 20 denotes a container body. The container body 20 is a bottle-type container including a mouth tubular portion 21, a shoulder portion 22, and a trunk portion 23 connecting to the mouth tubular portion 21 via the shoulder portion 22. An inside of the container body 20 is filled with a content medium M.

To the container body 20, a pump unit P is fixed. The pump unit P includes a first cylinder 31 that is located inside the mouth tubular portion 21. The first cylinder 31 includes a small-diameter portion 31a and a large-diameter portion 31b, and an ambient air introduction hole 31n formed between the small-diameter portion 31a and the large-diameter portion 31b. The large-diameter portion 31b is provided with an upper end flange 32. With the upper end flange 32 being received and rest on an upper end of the mouth tubular portion 21, the first cylinder 31 is held inside the mouth tubular portion 21 in a hanging manner. The first cylinder 31 also includes a fitting tube 33 that is connected to the upper end flange 32. The fitting tube 33 is fixed to the mouth tubular portion 21 by a fixing means C₁. As illustrated in the figure, the fixing means may be a screw means. However, according to the present invention, the fixing means C₁ is not limited to the screw means. There is also provided an annular seal member S to seal between the mouth tubular portion 21 and the upper end flange 32. From the upper end flange 32, a guiding tube 34 also stands.

The small-diameter portion 31a of the first cylinder 31 is formed, on an inner side thereof, with an annular concave groove 31c extending circumferentially about a pump axis line (hereinafter, called “axis line”) O₁. To the small-diameter portion 31a, an intake pipe 35, which communicates with the inside of the container body 20, is fixed. The content medium M drawn through the intake pipe 35 is introduced to an inside of the first cylinder 31 via a check valve 36. Inside the first cylinder 31, a pump plunger 38 is elastically supported via a spring 37.

The pump plunger 38 includes a plunger body 38a. The plunger body 38a includes a first piston 38b and a second piston 38c. The first piston 38b and the second piston 38c are integrally coupled via a plurality of ribs 38d that are located around the plunger body 38a at an interval. The first piston 38b, together with the small-diameter portion 31a of the first cylinder 31, forms a first pump chamber R₁. The first pump chamber R₁ has a pressure that is released when the first piston 38b reaches the annular concave groove 31c. An upper end opening of the first cylinder 31 is sealed by a lower end tube 39a included in a second cylinder 39. The lower end tube 39a, upon reaching the small-diameter portion 31a of the first cylinder 31, allows the ambient air introduction hole 31n to communicate with the outside. The second cylinder 39 also includes an upper end tube 39b formed with an opening, which is sealed by a cylinder cap 40. The cylinder cap 40, together with the upper end tube 39b of the second cylinder 39, defines space for accommodating the second piston 38c. Between the second piston 38c and the cylinder cap 40, a second pump chamber R₂ is also formed. The second pump chamber R₂ communicates with the first pump chamber R₁ through a gap formed between adjacent ribs 38d around the pump plunger 38. Furthermore, in the cylinder cap 40, an upper end opening A₁ is formed for allowing the first pump chamber R₁ and the second pump chamber R₂ to communicate with the outside. The upper end opening A₁ may be opened and closed by a tip portion 38a₁ of the plunger body 38a. Accordingly, the tip portion 38a₁ serves as a check valve (a discharge valve).

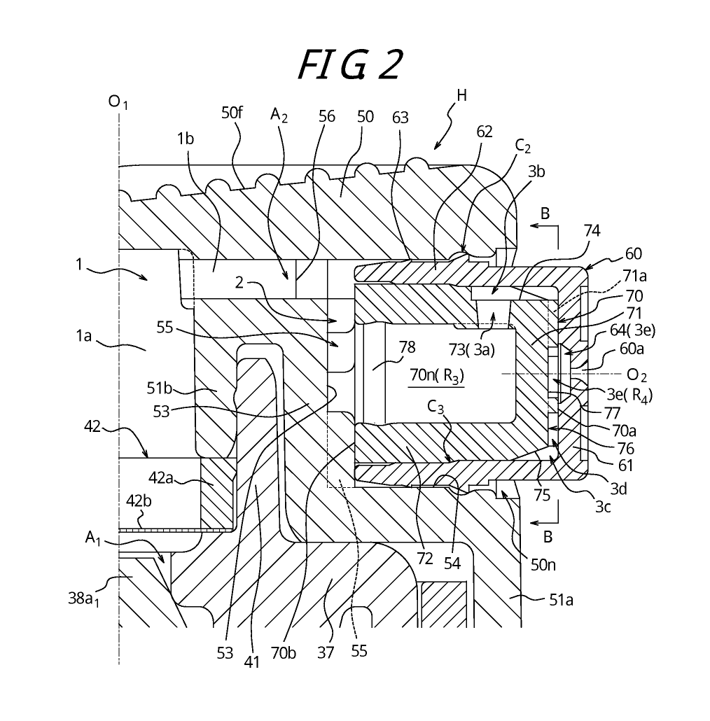

Moreover, the cylinder cap 40 is provided with a stem 41 surrounding the upper end opening A₁. Inside the stem 41, a mesh ring 42 is disposed. As illustrated in FIG. 2, the mesh ring 42 is configured by a ring member 42a and a mesh member 42b adhered to one end of the ring member 42a. The mesh ring 42 may be disposed in plurality inside the stem 41. The mesh ring 42 may also be omitted.

Reference numeral H denotes the spray head constituting the pump unit P. The spray head H includes a pressing member 50 that is to be operated by a user. The pressing member 50 has a cylindrical shape in appearance, with an upper end thereof being formed as a pressing surface 50f. The pressed member 50 is also provided, in a lower end thereof, with an outer tubular portion 51a and an inner tubular portion 51b that are integrated. As illustrated in FIG. 1, the outer tubular portion 51a includes a slip-off preventing portion 51c. The slip-off preventing portion 51c slides over a slip-off preventing portion 34c formed in the guiding tube 34 to be fitted and then locked by the slip-off preventing portion 34c. Thus, the pressing member 50 is held by the guiding tube 34 in a manner such that the pressing member 50 is prevented from slipping off. The inner tubular portion 51b of the pressing member 50 is also fitted and held inside the stem 41. Furthermore, the pressing body 50 is formed, inside thereof, with an introduction path 1 into which the content medium M pumped through the mesh ring 42 is introduced. The introduction path 1 includes a vertical flow path 1a, which includes an opening on an inner side of a lower end of the inner tubular portion 51b and which extends along the axis line O₁, and a front-rear (horizontal) flow path 1b, which extends from the flow path 1a toward a side surface of the pressing member 50. As illustrated in FIG. 2, the front-rear flow path 1b communicates with a concavity 50n formed on the side surface of the pressing member 50.

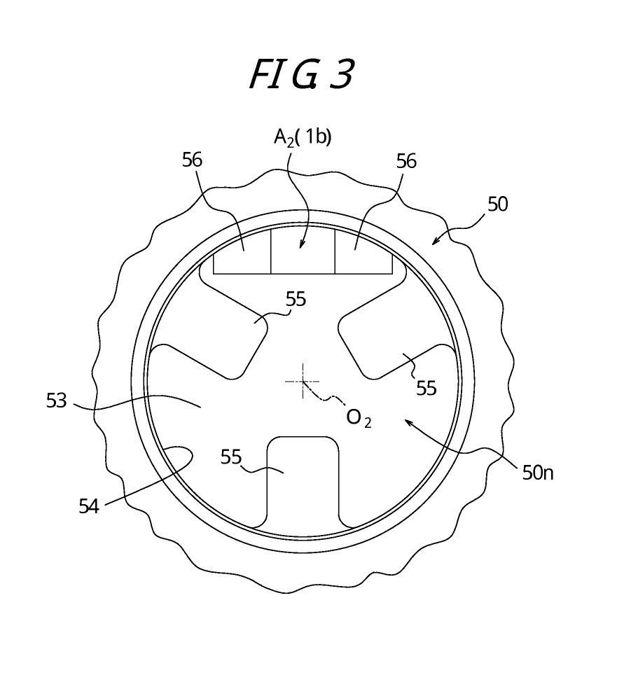

FIG. 3 is a front view of the concavity 50n. The concavity 50n is formed in a cylindrical shape. The concavity 50n includes a flat partition wall 53 that is integrally provided with a plurality of bumps 55. The bumps 55 each extend from an inner circumferential surface 54 of the concavity 50n toward a center O₂ of the concavity 50n. The front-rear flow path 1b has an opening A₂ formed in an upper position of the concavity 50n that is near the pressing surface 50f. On both sides of the opening A₂, stepped surfaces 56 connecting to the partition wall 53 are also formed.

Next, with reference to FIG. 2, reference numeral 60 denotes a nozzle tip that is fixed to the concavity 50n. The nozzle tip 60 includes a partition wall 61 that is provided with an ejection orifice 60a. The nozzle tip 60 also includes a circumferential wall 62 connected to the partition wall 61, thus forming a concavity inside the nozzle tip 60. The circumferential wall 62 of the nozzle tip 60 is fixed to the concavity 50n. In detail, the circumferential wall 62 of the nozzle tip 60 is fixed to the inner circumferential surface 54 of the concavity 50n by a fixing means C₂. As illustrated in the figure, the fixing means C₂ may be configured by an annular groove and an annular projection. The circumferential wall 62 is also provided with an annular sealing portion 63 that seals the inner circumferential surface 54 of the concavity 50n. The inner circumferential surface 54 of the concavity 50n is sealed by the nozzle tip 60. With the above configuration, the opening of the concavity 50n is tightly closed by the partition wall 61 of the nozzle tip.

Reference numeral 70 denotes an insert member that is located inside the nozzle tip 60 and that forms a communication path 3 that allows the introduction path 1 formed in the pressing member 50 to communicate with the ejection orifice 60a. As illustrated in FIG. 2, the insert member 70 includes a partition wall 71 that is fitted to an inner side of the partition wall 61 of the nozzle tip. The insert member 70 also includes a circumferential wall 72 connected to the partition wall 71, thus forming a concave portion 70n inside the insert member 70.

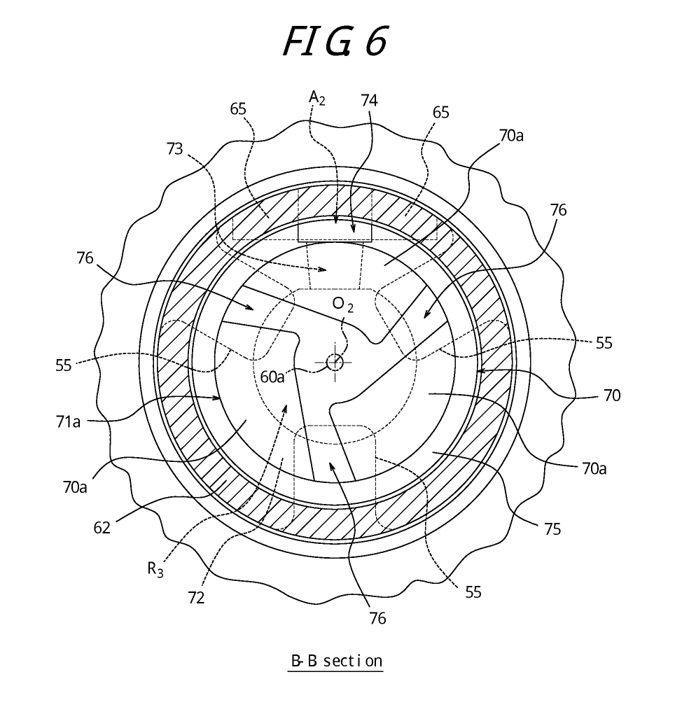

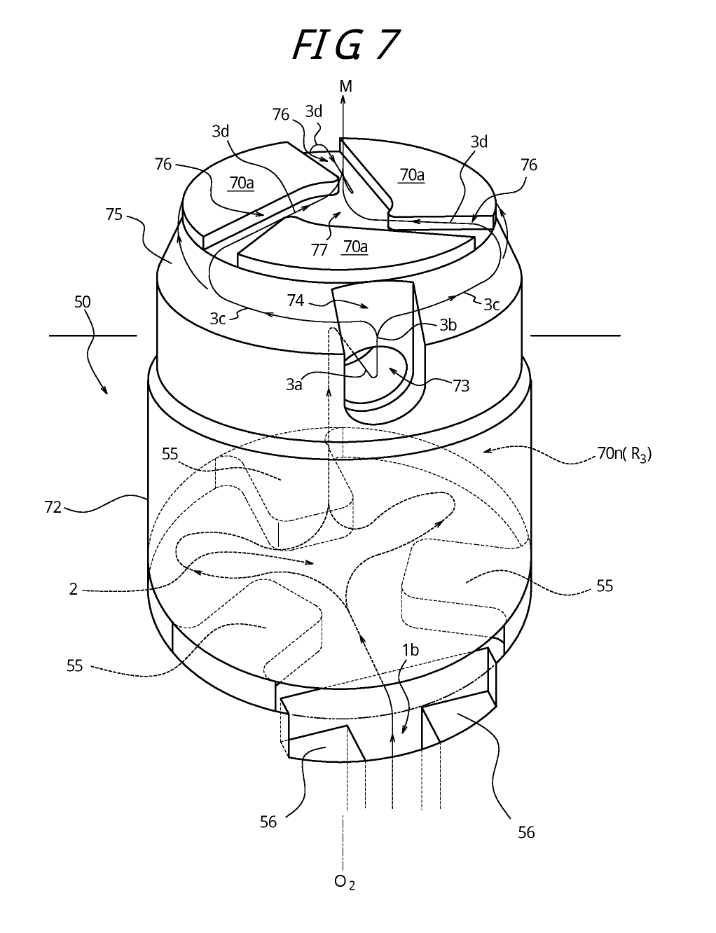

The concave portion 70n includes an opening formed in a rear end 70b of the concave portion 70n in a manner such that the opening and the partition wall 53 of the pressing member 50 face to each other. The rear end 70b is in contact with the three bumps 55 provided in the pressing member 50, thereby forming a gap oriented to the center O₂ under the guide of the bumps 55 between the rear end 70b and the partition wall 53 (refer to FIG. 7). Furthermore, as illustrated in FIG. 2, the circumferential wall 72 of the insert member 70 is fixed inside the circumferential wall 62 of the nozzle tip by a fixing means C₃. As illustrated in the figure, the fixing means C₃ may be implemented by press fitting for sealing an inner circumferential surface of the circumferential wall 62 of the nozzle tip by the circumferential wall 72 of the insert member. The concave portion 70n in the insert member 70, along with the nozzle tip 60, is fixed to the concavity 50n in the pressing member 50. By doing so, a guiding path 2, which allows the opening A₂ of the introduction path 1 to communicate with the concave portion 70n, is formed between the concave portion 70n and the partition wall 53. Accordingly, the concave portion 70n serves as a filling space R₃ to be filled with the content medium M introduced via the introduction path 2. In the present embodiment, an annular groove 78 is also formed on a portion of an inner circumferential surface of the circumferential wall 72 that is located close to the rear end 70b of the insert member. The annular groove 78 has a semi-circular shape in its section. Furthermore, as illustrated in FIG. 6, the section of the filling space R₃ is in the form of a segment of a circle in which a portion of the circular appearance is replaced by a chord. However, according to the present invention, the section of the filling space R₃ may also be but not limited to any other shape such as a circular shape.

On the other hand, the circumferential wall 72 is formed with a single through hole 73 that allows the concave portion 70n to communicate with the outside. As illustrated in FIG. 2, the through hole 73 is a slant hole having a diameter that is increased in a direction from an inside to an outside of the insert member 70. According to the present invention, the through hole 73 may also have a constant diameter in the direction from the inside to the outside of the insert member 70. The circumferential wall 72 is also formed with a long groove 74 that extends from the through hole 73 to the nozzle tip 60. As described above, the circumferential wall 72 seals the inner circumferential surface of the circumferential wall 62 of the nozzle tip. Accordingly, the long groove 74 in the insert member forms the communication path 3 between the insert member and the circumferential wall 62 of the nozzle tip 60. The communication path 3 includes a first communication path 3a, which is configured by the through hole 73, and a second communication path 3b, which communicates with the filling space R₃ via the first communication path 3a.

The insert member 70 also has a front end 70a facing to the nozzle tip 60 that is formed as a flat surface. The front end 70a also has an outer circumferential edge that is formed as an annular inclined surface 75 tapered toward a front end thereof. Furthermore, the front end 70a is formed with a bulging portion 71a that protrudes forward of the inclined surface 75. With the above configuration, an annular third communication path 3c extending circumferentially about the center O₂ is formed between the inclined surface 75 and the nozzle tip 60. The third communication path 3c distributes the content medium M drawn from the second communication path 3b around the center O₂ (refer to FIG. 7).

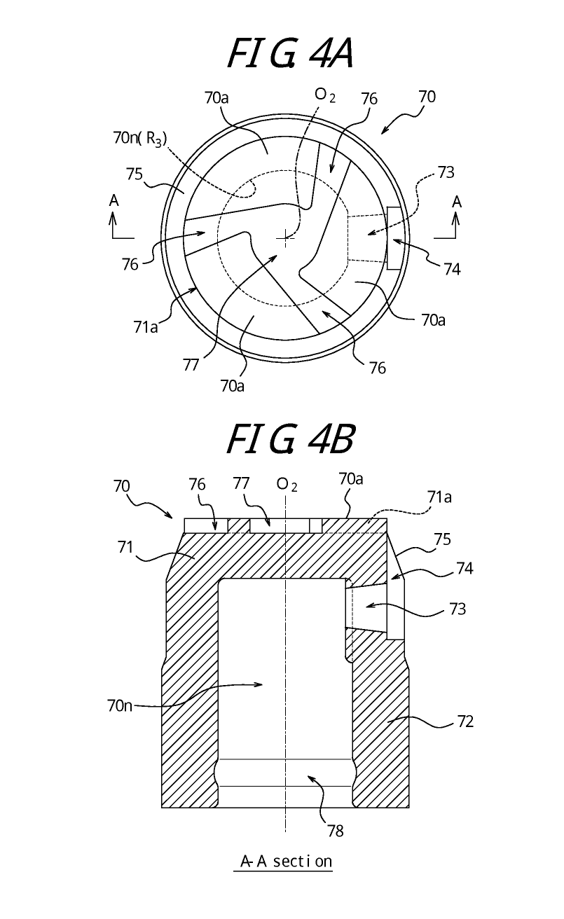

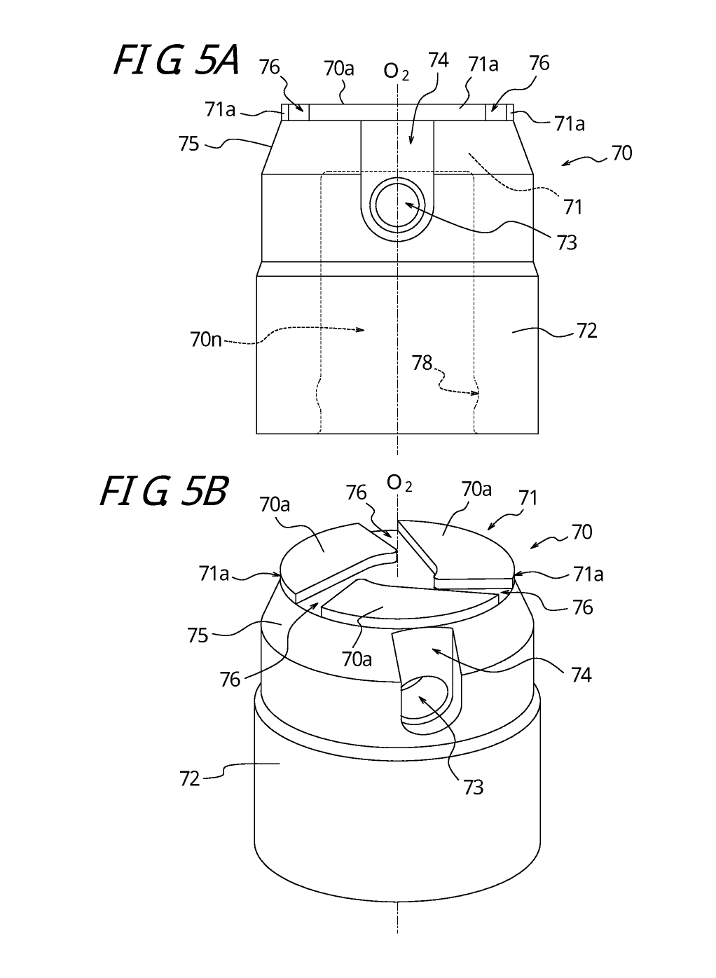

As illustrated in FIG. 4 (in particular, FIG. 4A), the bulging portion 71a is also formed with three radial grooves (spin grooves) 76 arranged at an interval about the center O₂ and formed, in the center O₂, with a cylindrical groove 77 where the radial grooves 76 join. In the present embodiment, as illustrated in FIG. 4A, the radial grooves 76 are each inclined to be tapered toward the cylindrical groove 77 about the center O₂. Furthermore, as illustrated in FIG. 5 (in particular, FIG. 5B), each radial groove 76 is formed in a position that is circumferentially offset from the long groove 74 (about the center O₂). Accordingly, the long groove 74 is arranged to bypass the radial groove 76 in the circumferential direction. However, according to the present invention, the radial groove 76 may also be formed in a position that is circumferentially aligned with the long groove 74. In this case, the long groove 74 may be in direct communication with the radial groove 76 without bypassing the radial groove 76 in the circumferential direction. As illustrated in FIG. 2, the front end 70a contacts the partition wall 61 of the nozzle tip 60 to seal between the front end 70a and the partition wall 61. Accordingly, the radial grooves 76 form three fourth communication paths 3d into which the content medium M drawn from the annular third communication path 3c is introduced, and the cylindrical groove 77 forms a fifth communication path 3e into which the content medium M drawn from the fourth communication paths 3d is introduced. The fifth communication path 3e serves as a junction space R₄ that communicates to the outside via the ejection orifice 60a. In the present embodiment, the fifth communication path 3e is formed in corporation with a concavity 64 formed in the partition wall 61 of the nozzle tip 60.

With reference to FIG. 1, in the present embodiment, as usual, in response to repeated pressing and return movements of the spray nozzle H, the content medium M contained in the container body 20 is sucked to the pump chamber R₁ and the pump chamber R₂ and is pressurized. Subsequently, as the upper end opening A₁ in the stem 41 is released by the tip portion 38a₁ of the plunger body 38a, the pressurized content medium M is pumped to the mesh ring 42 through the upper end opening A₁. After passing through the mesh ring 42, the content medium M keeps its high pressure.

Next, with reference to FIG. 2, the content medium M passes though the introduction path 1 to be pumped into the guiding path 2. Thus, the content medium M is introduced to the filling space R₃. The content medium M introduced to the filling space R₃ then passes through the first communication path 3a (the through hole 73) and the second communication path 3b (the long groove 74) to be introduced to the third communication path 3c (the annular inclined surface 75). The content medium introduced to the third communication path 3c is divided into two partial flows along the third communication path 3c and swirl around the third communication path 3c. At this time, the content medium M introduced to the third communication path 3c enters the three fourth communication paths 3d and is introduced to the fifth communication path 3e from the three fourth communication paths 3d. The content medium M introduced to the fourth communication path 3d is introduced to the fifth communication path 3e as a swirling flow flowing in the four communication path 3d as a spinning flow path and is sprayed to the outside through the ejection orifice 60a.

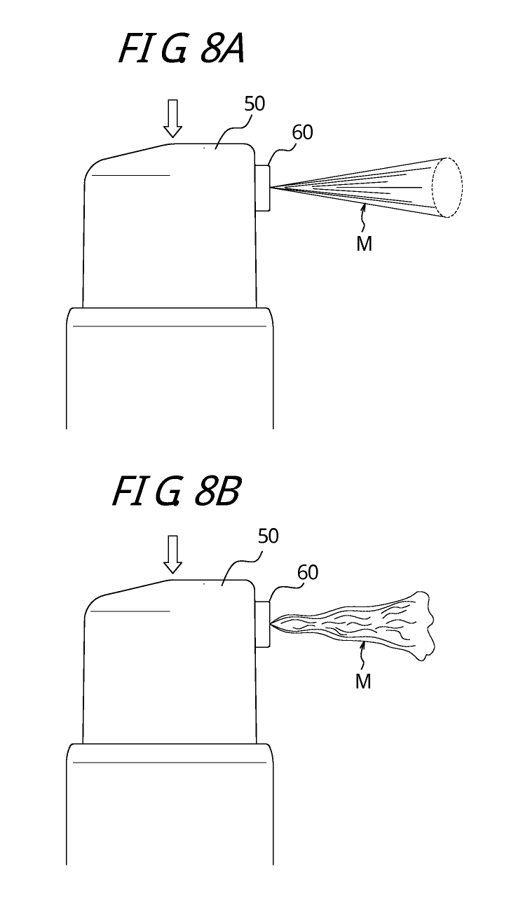

That is to say, the communication path formed between the nozzle tip 60 and the insert member 70 includes the first communication path 3a (the through hole 73), the second communication path 3b (the long groove 74), the third communication path 3c (the annular inclined surface 75), the fourth communication paths 3d (the radial grooves 76), and the fifth communication path 3e (the cylindrical groove 77). As illustrated in FIG. 8A, the above configuration further stabilizes ejection patterns, which are defined by states, angles, or the like of spraying, as can be seen clearly from comparison with conventional ejection patterns illustrated in FIG. 8B.

In particular, as illustrated in FIG. 7, since in the present embodiment the second communication path 3b is located in the position that is circumferentially offset from the fourth communication paths 3d, the content medium M drawn from the first communication path 3a is imparted with a rotational force while passing through the outer third communication path 3c before being introduced to the fourth communication paths 3d. In the fourth communication paths 3d, a greater rotational force is imparted to the content medium M. As a result, using the spray head H according to the present invention facilitates application of a spinning (rotational) force to the content medium M drawn from the first communication path 3a to achieve spray patterns that are even more improved. Thus, the present embodiment prevents the introduced content medium M from being biased to any of the fourth communication paths 3d before being sprayed.

In contrast, when the second communication path 3b is located in a position that is circumferentially aligned with the fourth communication paths 3d, the introduced content medium M is biased toward the fourth communication paths 3d. Accordingly, in the present invention, when a plurality of the first communication paths 3a (the through holes 73), along with the plurality of fourth communication paths 3d (the radial grooves 76), are formed, it is only necessary that at least one of the plurality of the first communication paths 3a (the through holes 73) be located in a position that is circumferentially offset from any of the plurality of fourth communication paths 3d (the radial grooves 76).

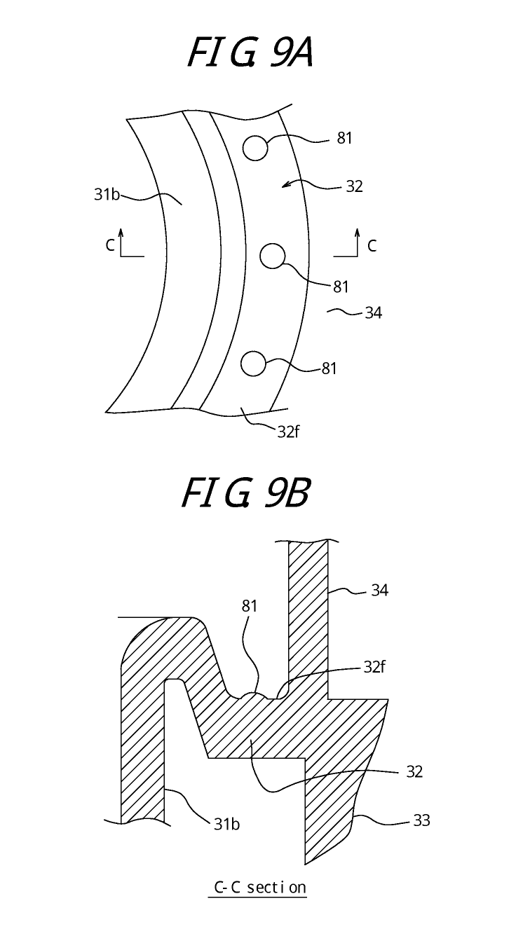

Reference is now made to FIGS. 9A and 9B which illustrate, as a modified example of the above embodiment, a mechanism for reducing collision noise generated when the spray head H is pushed down. The collision noise reduction mechanism includes a protrusion 81 formed on the upper end flange 32 connecting the first cylinder 31 and the fitting tube 33 according to the above embodiment. The protrusion 81 protrudes from an upper end surface 32f of the upper end flange 32 toward a lower end surface 51f of the pressing member 50. The protrusion 81 may be arranged on a part of the upper end surface 32f or may be arranged at an interval about the axis line O₁. In the present example, a plurality of protrusions 81 are arranged at an equal interval about the axis line O₁.

Each protrusion 81 comes into contact with the lower end surface 51f of the pressing member 50 when the spray head H is pushed down. Accordingly, the protrusion 81 determines a lower limit of how far down the spray head H may be pushed down. In the present example, since the protrusion 81 is formed on the upper end flange 32, when the spray head H is pushed down, the lower end surface 51f of the pressing member 50 comes into partial contact with the protrusion 81 formed on the upper end flange 32. In this case, compared with a case where the lower end surface 51f of the pressing member 50 comes into full contact with the upper end surface 32f, a contact area between the spray head H and the upper end flange 32 is reduced. Accordingly, collision noise generated due to contact between the spray head H and the upper end flange 32 (the first cylinder) is effectively reduced or prevented.

Furthermore, in the present example, as illustrated in FIG. 9B, each protrusion 81 is formed in a dome shape (a semi-spherical shape). The protrusion 81 may be made of an elastic resin and may be made integrally with or separately from the upper end flange 32. In this case, when the spray head H is pushed down to bring the lower end surface 51f of the pressing member 50 into contact with the protrusion 81, the protrusion 81 undergoes a small degree of elastic compressive deformation. Accordingly, the collision noise is further reduced or prevented.

Moreover, the pump unit P according to the present embodiment is suited for use in an accumulator dispenser that, when the spray head H is pushed down, increases pressure in the first cylinder 31 to eject the content medium M contained in the container body 20 from the ejection orifice 60a. In such an accumulator dispenser, the ejection of the content medium M might cause a rapid decrease in a reaction force against the pushing-down of the spray head H, possibly resulting in an increase in a speed of contact between the lower end surface 51f of the pressing member 50a and the upper end flange 32. In this circumstance, a loud collision noise is likely to be generated. However, the dispenser according to the present example is capable of minimizing such a loud collision noise.

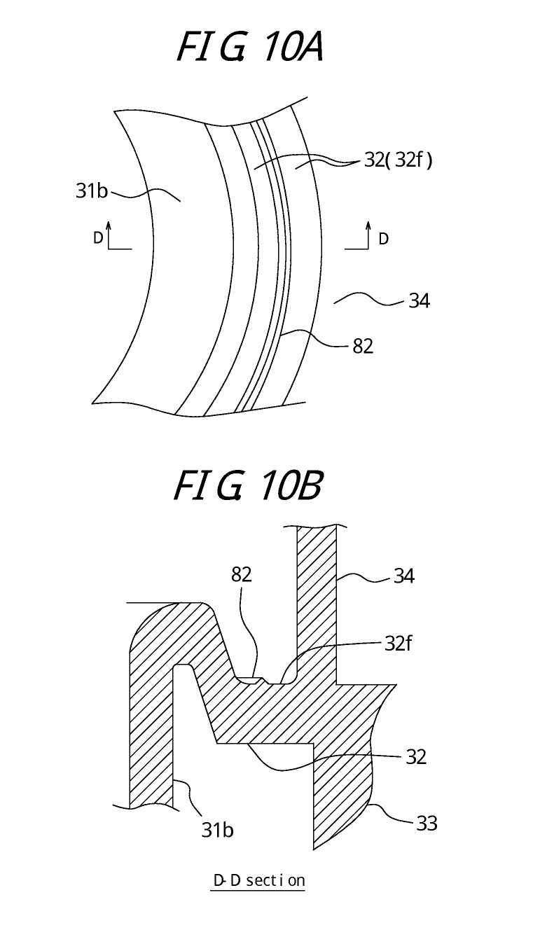

FIGS. 10A and 10B illustrate another example of the collision noise reduction mechanism. The illustrated collision noise reduction mechanism includes another type of protrusion formed on the upper end flange 32. In the present example, an annular protrusion 82, extending circumferentially about the axis line O₁, is formed on the upper end flange 32. As illustrated in FIG. 10B, the protrusion 82 is shaped in an angle section and may be configured in the same manner as the aforementioned protrusion 81. The protrusion 82 also determines the lower limit of how far the spray head H may be pushed down and helps reduce the contact area between the spray head H and the upper end flange 32. Accordingly, with the protrusion 82 also, the collision noise is effectively reduced or prevented.

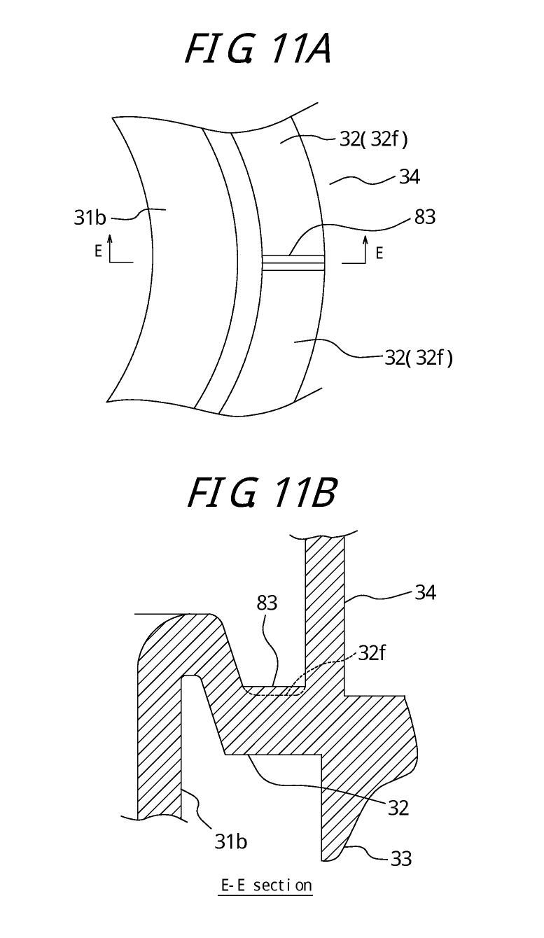

FIGS. 11A and 11B illustrate yet another example of the collision noise reduction mechanism. The illustrated collision noise reduction mechanism includes yet another type of protrusion formed on the upper end flange 32. In the present example, a radially extending protrusion 83 is formed on the upper end flange 32. In the present example, as illustrated in FIG. 11A, the protrusion 83 is shaped in an angle section and is formed in a linear shape connecting the large-diameter portion 31b of the first cylinder 31 and the guiding tube 34. The protrusion 83 may be arranged on a part of the upper end surface 32f or may be arranged at an interval about the axis line O₁. For example, a plurality of protrusions 83 may be radially arranged at an equal interval about the axis line O₁. The protrusion 83 may be configured in the same manner as the aforementioned protrusion 81. The protrusion 83 also determines the lower limit of how far the spray head H may be pushed down and helps reduce the contact area between the spray head H and the upper end flange 32. Accordingly, with the protrusion 83 also, the collision noise is effectively reduced or prevented.

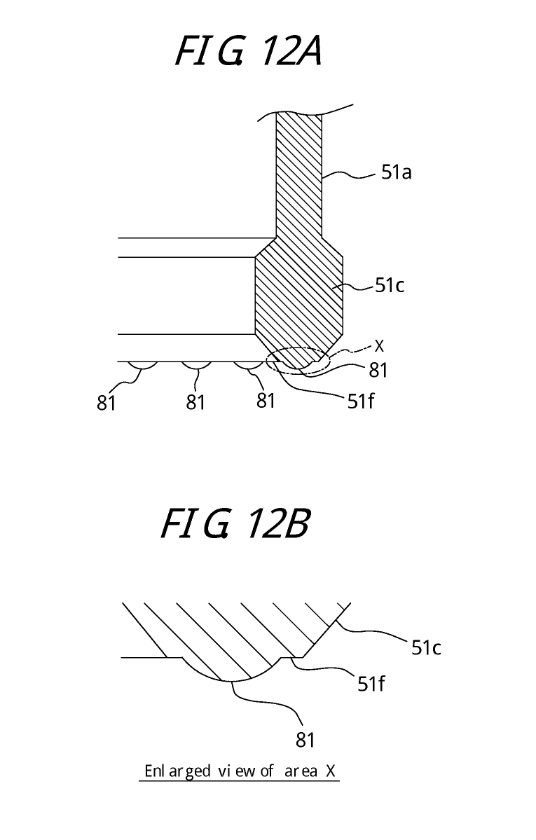

FIGS. 12A and 12B illustrate the collision noise reduction mechanism formed on the side of the spray head H instead of on the side of the container body 20. In the present example, the aforementioned protrusion 81 is formed on the lower end surface 51f of the pressing member 50. In this case, the shape, number, and arrangement of the protrusion 81 formed on the lower end surface 51f of the pressing member 50 may be determined in the same manner as the case of the protrusion 81 formed on the upper end flange 32. That is to say, the protrusion 81 formed on the lower end surface 51f of the pressing member 50 also determines the lower limit of how far the spray head H may be pushed down and helps reduce the contact area between the spray head H and the upper end flange 32. Accordingly, with the protrusion 81 formed on the lower end surface 51f also, the collision noise is effectively reduced or prevented.

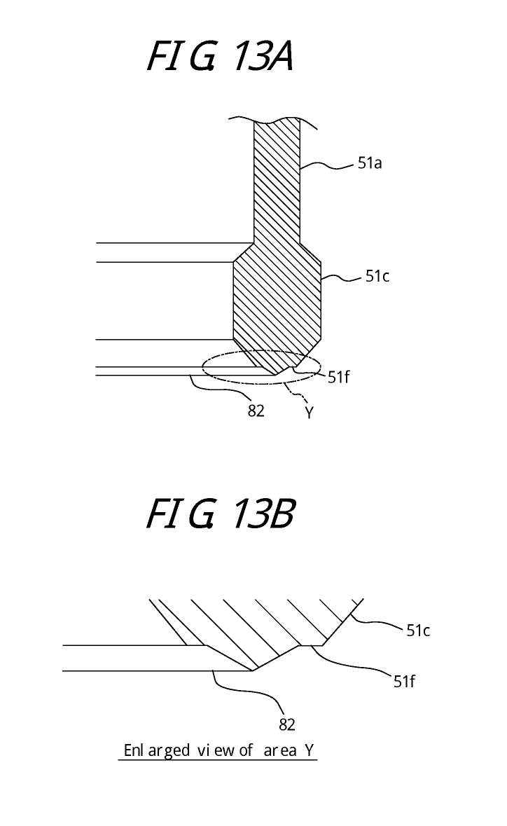

FIGS. 13A and 13B illustrate another example of the collision noise reduction mechanism formed on the side of the spray head H. In the present example, the aforementioned annular protrusion 82 is formed on the lower end surface 51f of the pressing member 50. In this case, the shape, number, and arrangement of the protrusion 82 formed on the lower end surface 51f may be determined in the same manner as the case of the protrusion 82 formed on the upper end flange 32. That is to say, the protrusion 82 formed on the lower end surface 51f of the pressing member 50 also determines the lower limit of how far the spray head H may be pushed down and helps reduce the contact area between the spray head H and the upper end flange 32. Accordingly, with the protrusion 82 formed on the lower end surface 51f also, the collision noise is effectively reduced or prevented.

The protrusions are not limited to have the dome shape and the shape with the angle section as described above, and a truncated conical shape, a truncated pyramid shape, a shape with a semi-cylindrical section, and the like may also be adopted. Furthermore, instead of the annular protrusion 82, a plurality of circumferential ridges may be formed in at least one position on the same circumference extending about the axis line O₁, For example, the plurality of circumferential ridges may be arranged on the same circumference at an interval, preferably at an equal interval. Moreover, the protrusion may be formed on each of the upper end flange 32 and the lower end surface 51f of the pressing member 50, in positions that allow these protrusions to come into contact with each other or in alternate positions that prevent these protrusions from coming into contact with each other. That is to say, the protrusion may be formed on at least one of the upper end flange 32 and the lower end surface 51f of the pressing member 50. The position of the protrusion is not limited to the upper end flange 32 and the lower end surface 51f of the pressing member 50 if only the protrusion may help reduce or prevent the collision noise when the spray head H is pushed down.

The embodiment of the present invention is described by way of example, and various changes may be made within the scope of the claims. For example, the ejection head H is not limited to the spray (atomizer) head and may dispense the content in the original form of the content, such as emulsion, or in the form of foam. Although in the above embodiment the ejection head is incorporated to the pump unit, according to the present invention, the ejection head may be configured as an individual member.

### INDUSTRIAL APPLICABILITY

The present invention is applicable, for example, as a liquid ejecting device in the fields of cosmetics such as face lotion and hair liquid, medicine such as an insect repellant, and beauty and health products.

### REFERENCE SIGNS LIST

1 introduction path
1a vertical flow path
1b front-rear flow path
2 guiding path
3 communication path
3a first communication path
3b second communication path
3c third communication path
3d fourth communication path
3e fifth communication path
10 pump bottle container
20 container body
21 mouth tubular portion
22 shoulder portion
23 trunk portion
30 pump unit
31 first cylinder
31a small-diameter portion
31b large-diameter portion
31n ambient air introduction hole
32 upper end flange
32f upper end surface of upper end flange
33 fitting tube
34 guiding tube
34c slip-off preventing portion
35 intake pipe
36 check valve
37 spring
38 pump plunger
38a plunger body
38a₁ tip portion of plunger body
38b first piston
38c second piston
38d rib
39 second cylinder
39a lower end tube of second cylinder
39b upper end tube of second cylinder
40 cylinder cap
41 stem
42 mesh ring
42a ring member
42b mesh member
50 pressing member
50f pressing surface
50n concavity
51 tubular portion
51a outer tubular portion
51b inner tubular portion
51c slip-off preventing portion
51f lower end surface of pressing member
52 circumferential wall
53 partition wall
54 inner circumferential surface of concavity
55 bump
56 stepped portion
60 nozzle tip
60a ejection orifice
61 partition wall
62 circumferential wall
63 sealing portion
64 concavity
70 insert member
70a front end
70b rear end
70n concave portion
71 partition wall
71a bulging portion
72 circumferential wall
73 through hole
74 long groove
75 inclined surface
76 radial groove (spin groove)
77 cylindrical groove
78 annular groove
81 protrusion
82 protrusion
83 protrusion
A₁ upper end opening
A₂ opening
C₁ fixing means
C₂ fixing means
C₃ fixing means
H spray head (ejection head)
O₁ first pump chamber
O₂ center of concavity
R₁ first pump chamber
R₂ second pump chamber
R₃ filling space
S seal member

1. An ejection head, comprising:
a pressing member that is fitted to a stem standing from a mouth tubular portion of a container body and that is formed with an introduction path to which a content medium is introduced; a nozzle tip that is fitted to a concavity formed on a side surface of the pressing member and that is formed with an ejection orifice for the content medium pumped from the introduction path; and an insert member that is located inside the nozzle tip and that forms a communication path allowing the introduction path formed in the pressing member to communicate with the ejection orifice formed in the nozzle tip, wherein
the insert member includes: a concave portion having an opening formed in a rear end of the insert member that faces to the pressing member, thereby forming a filling space to be filled with the content medium introduced from the introduction path; at least one through hole formed on a circumferential wall constituting the concave portion; and a long groove that is formed on the circumferential wall and that extends from the at least one through hole to the nozzle tip, and
the insert member has a front end facing to the nozzle tip, the front end having an outer circumferential edge formed as an annular inclined surface tapered toward a front end thereof, and the front end being formed with a bulging portion that protrudes forward of the inclined surface, the bulging portion being formed with a plurality of radial grooves and a cylindrical groove where the plurality of radial grooves joins, and at least one of the at least one through hole is located in a position that is circumferentially offset from the plurality of radial grooves.

2. The ejection head of claim 1, wherein the at least one through hole comprises a slant hole having a diameter that is increased in a direction from an inside to an outside of the insert member.

3. The ejection head of claim 1, wherein the introduction path includes an opening formed in an upper position, the opening allowing the introduction path to communicate with the filling space.

4. The ejection head of claim 1, wherein the concavity is provided with a plurality of bumps that form a plurality of radial grooves and a cylindrical groove where the plurality of radial grooves joins, and by bringing the insert member into abutment with the plurality of bumps, a guiding path allowing the introduction path to communicate with the communication path is formed.

5. The ejection head of claim 1, wherein the at least one through hole comprises a single through hole that is located in the position that is circumferentially offset from the plurality of radial grooves.

6. A container, comprising:
the ejection head of claim 1; and a container body including a pump having a stem to which the ejection head is fitted.
